(19) United States
(12) Patent Application Publication
(10) Pub. No.: US 2022/0250493 A1
(43) Pub. Date: Aug. 11, 2022

(54) On-Board Charger and Method for Charging a High-Voltage Battery of a High-Voltage On-Board Electrical System or a Low-Voltage Battery of a Low-Voltage On-Board Electrical System

(71) Applicant: Daimler AG, Stuttgart (DE)

(72) Inventors: Urs BOEHME, Ehningen (DE); Akin CANDIR, Filderstadt (DE); André HASPEL, Sindelfingen (DE)

(21) Appl. No.: 17/611,003

(22) PCT Filed: Mar. 6, 2020
(86) PCT No.: PCT/EP2020/055997

§ 371 Date: Nov. 12, 2021

(30) Foreign Application Priority Data
May 15, 2019 (DE) 10 2019 003 458.9

(51) Int. Cl. B60L 53/22; H02M 1/42; H02M 3/335; B60L 53/60

(52) U.S. Cl. CPC B60L 53/22; H02M 1/4208; H02M 3/33561; B60L 2210/10; B60L 53/60; H02J 2207/20; H02M 3/33569

(57) ABSTRACT

An on-board charger for charging a high-voltage battery of a high-voltage on-board electrical system or a low-voltage battery of a low-voltage on-board electrical system includes a first DC converter which has a transformer having a primary side and a secondary side where the high-voltage battery can be supplied with a first DC voltage via a first circuit of the secondary side of the first DC converter. The low-voltage battery can be supplied with a second DC voltage via a second circuit of the secondary side. A control unit activates either the first circuit or the second circuit of the secondary side of the first DC converter. For operating the low-voltage on-board electrical system by the high-voltage battery, the first DC converter is configured such that the first DC converter converts a battery voltage of the high-voltage battery into the second DC voltage in the second circuit of the secondary side.

### BACKGROUND AND SUMMARY OF THE INVENTION

The invention relates to an on-board charger for charging a high-voltage battery of a high-voltage on-board electrical system or a low-voltage battery of a low-voltage on-board electrical system. The on-board charger comprises a line filter for filtering an AC voltage and a power factor correction filter for adjusting an input current. Furthermore, the on-board charger comprises a first DC converter which has a transformer having a primary side and a secondary side, wherein the first DC converter can be used to supply the high-voltage battery with a first DC voltage via a first circuit of the secondary side of the first DC converter. Furthermore, the on-board charger comprises a DC voltage filter. Furthermore, the invention relates to a method for charging a high-voltage battery of a high-voltage on-board electrical system or a low-voltage battery of a low-voltage on-board electrical system.

Electric vehicles or plug-in vehicles have the option of charging a high-voltage battery at a charging station or at a household connection in single or multiple phases with an on-board charger. The high-voltage battery supplies further high-voltage components, such as the electric drive(s), an air conditioning system, a heater or an infotainment system. Furthermore, there is also a DC converter that generates a low voltage from the high voltage of the high-voltage battery and supplies the 12 V on-board electrical system.

US 2010/0231169 A1 discloses a motor vehicle which comprises an electrical circuit and can be electrically connected to an electrical network. Furthermore, the motor vehicle comprises an electric drive electrically connected to the circuit, and a power conversion module electrically connected to the electric drive. With an energy storage unit, the energy converter is electrically connected to a module.

Here, the disadvantage arises that a plurality of electrical circuits and components are required for a charging operation of a high-voltage battery and/or a low-voltage battery.

The object of the present invention is to provide an on-board charger and a method with which an on-board charger can be functionally extended such that synergies can be used.

One aspect of the invention relates to an on-board charger for charging a high-voltage battery of a high-voltage on-board electrical system or a low-voltage battery of a low-voltage on-board electrical system. The on-board charger has a line filter for filtering an AC voltage and a power factor correction filter for adjusting an input current. With a first DC converter of the on-board charger, which has a transformer with a primary side and a secondary side, the high-voltage battery can be supplied with a first DC voltage via a first circuit of the secondary side of the first DC converter. Furthermore, the on-board charger comprises a DC voltage filter. A second circuit on the secondary side of the first DC converter can be used to supply the low-voltage battery with a second DC voltage. A control unit is designed in such a way that either the first circuit or the second circuit of the secondary side of the first DC converter can be activated. By splitting the secondary side of the first DC converter, synergies can be used. In particular, by using the first DC converter to supply the high-voltage battery and the low-voltage battery, the functions of an on-board charger and a DC converter can be used in a single component or switching arrangement. In particular, the on-board charger takes over the functions of the DC converter. In particular, this saves components, weight, volume and costs. By using the two functions of the two different components on one and the same housing, an additional cooling concept in particular can be dispensed with, since both functions can be cooled with the same cooling concept in the same housing. In particular, using the two functions on one housing reduces the number of interfaces, high-voltage lines and low-voltage lines. In particular, this makes it possible to keep power dissipation in the charging mode of the high-voltage battery or the low-voltage battery small, since several electronic components or circuits are not required.

The on-board charger can be used in particular to charge the high-voltage battery in single-phase or three-phase mode. In particular, the input AC voltage is first filtered with the line filter as the first part of the power stage. After this filtering, the power factor correction filter (PFC) can be used to adapt the input current to a course which is as sinusoidal as possible. In particular, the input current should be in phase with the mains voltage on the input side. This reduces, for example, the harmonics propagated back into the mains, and the power factor improves as a result. In addition, the PFC stage of the power factor correction filter generates a regulated output voltage by means of which the downstream DC converter can be supplied. The power factor correction filter is followed by the first DC converter, which provides galvanic isolation and generates an output voltage that behaves exactly according to the charging profile of the high-voltage battery. Before the rectified input voltage is made available to the high-voltage battery, the rectified input voltage is filtered using a DC voltage filter.

In particular, the on-board charger can be used to charge the high-voltage battery of the high-voltage on-board electrical system or the low-voltage battery of the low-voltage on-board electrical system of an electrically operable vehicle or a hybrid vehicle. In particular, the first DC converter has the transformer, which is divided into a primary side and a secondary side. By way of example, the primary side comprises a primary coil and the secondary side comprises a secondary coil. The secondary side of the first DC converter is in particular divided into two parts or into two separate secondary coils. The secondary coil of the secondary side is divided into a first secondary coil and a second secondary coil. If the high-voltage battery is to be charged during a charging process, the first secondary coil of the secondary side is switched to active with the aid of the control unit, whereby the high-voltage battery can be supplied or charged with the first DC voltage. In particular, the control unit clocks the charging operation and adapts the first DC voltage to the required charging voltage for the high-voltage battery. In particular, when the first secondary coil of the secondary side is active, the second secondary coil is deactivated.

By way of example, the activation of the second secondary coil of the secondary side and the simultaneous deactivation of the first secondary coil takes place during driving operation of the electrically operable vehicle or the hybrid vehicle. Here, the second secondary coil of the first DC converter is used to supply the low-voltage vehicle electrical system or the low-voltage battery with the second DC voltage. By way of example, the low-voltage on-board electrical system may be a 12 V on-board electrical system.

Another aspect of the invention relates to a method for charging a high-voltage battery of a high-voltage on-board electrical system or a low-voltage battery of a low-voltage on-board electrical system, wherein the high-voltage battery is charged with a first DC voltage which is generated with a first circuit of a secondary side of a transformer of a DC converter. The low-voltage is charged with a second DC voltage, which is generated with a second circuit of the secondary side of the DC converter, wherein it is monitored that only the low-voltage battery or only the high-voltage battery is charged.

In particular, the high-voltage battery or the low-voltage battery of an electrically operated vehicle or a hybrid vehicle is charged.

In particular, the first DC voltage is converted by converting an input AC voltage at an on-board charger. The DC converter is formed by a secondary side and a primary side and comprises a transformer having a primary coil and a secondary coil. The secondary side of the DC converter is divided into a first secondary coil and a second secondary coil. In the first circuit of the secondary side, the first secondary coil is actively switched, wherein the high-voltage battery of the high-voltage on-board electrical system can thereby be supplied or charged with the first DC voltage. In particular, the high-voltage battery is charged during a charging operation of the electrically operated vehicle or the hybrid vehicle. As soon as the low-voltage battery is to be charged, the first secondary coil can be deactivated and the second secondary coil of the secondary side can be activated such that the low-voltage battery can be charged with the second DC voltage. In particular, the low-voltage battery can be a battery of a 12 V on-board electrical system. In particular, it is monitored that only ever either the low-voltage battery or only the high-voltage battery can be charged. In particular, the low-voltage battery is charged via the battery voltage of the high-voltage battery.

Further advantages, features and details of the invention emerge from the following description of preferred exemplary embodiments and from the drawings. The features and combinations of features mentioned above in the description, as well as the features and combinations of features mentioned below in the description of figures and/or shown alone in the figures, can be used not only in the combination specified in each case, but also in other combinations or on their own, without departing from the scope of the invention.

### BRIEF DESCRIPTION OF THE DRAWINGS

FIG. 1 is a schematic representation of an on-board charger;

FIG. 2 is a schematic switching arrangement for charging a high-voltage battery; and

FIG. 3 is a schematic switching arrangement for charging a low-voltage battery.

### DETAILED DESCRIPTION OF THE DRAWINGS

In the figures, functionally identical elements are provided with the same reference numerals.

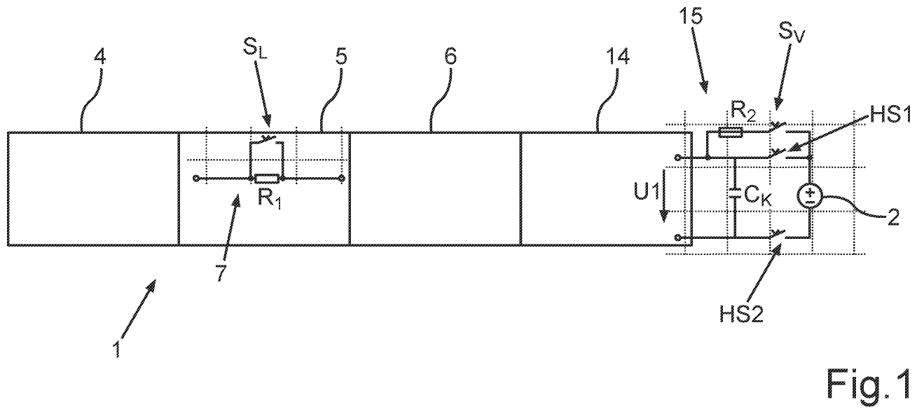

FIG. 1 shows an on-board charger 1 for charging a high-voltage battery 2 of a high-voltage on-board electrical system or a low-voltage battery 3 of a low-voltage on-board electrical system. The on-board charger 1 can be used, for example, for a single-phase or three-phase charging process of the high-voltage battery 2. In particular, the on-board charger can be used to charge the high-voltage battery 2 or the low-voltage battery 3 of an electrically powered vehicle or a hybrid vehicle. The on-board charger 1 has a line filter 4 on the input side. The line filter 4 can be used to filter an input-side AC voltage U_{AC} which is in contact with the input of the on-board charger 1. After the AC voltage U_{AC} has been filtered with the aid of the line filter 4, a power factor correction filter 5 is connected downstream, with which an input current of the AC voltage U_{AC} can be brought into a sinusoidal shape, in particular in phase with the AC voltage U_{AC}. In particular, the power factor correction filter 5 provides a regulated output voltage for the downstream DC converter 6. The power factor correction filter 5 comprises a pre-charging circuit 7 with which the following first DC converter 6 can be pre-charged. The pre-charging circuit 7 of the power factor correction filter 5 has a first resistor R₁ and a pre-charging switch S_{L}.

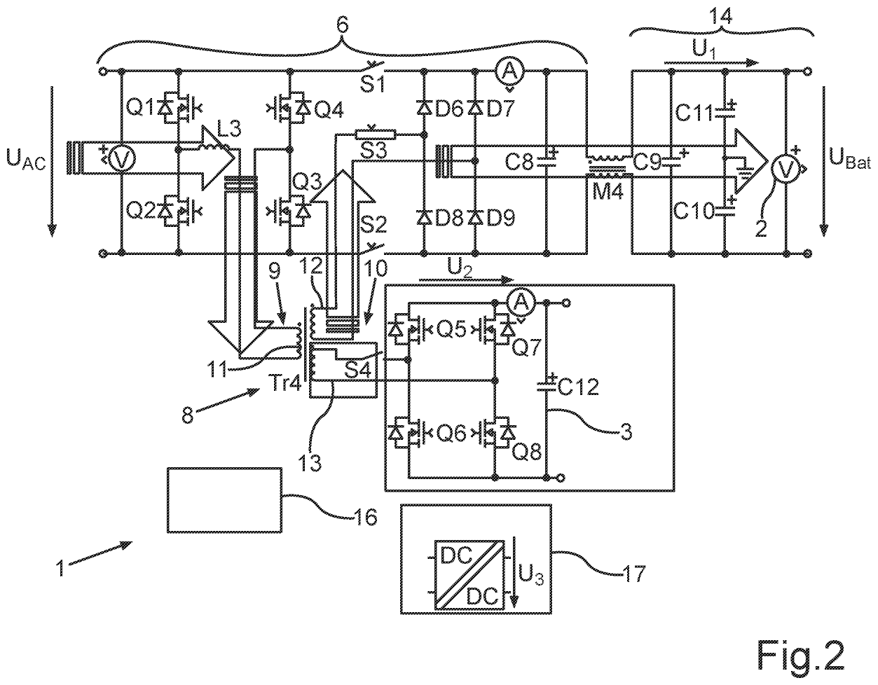

The first DC converter 6 comprises a transformer 8 (cf. FIG. 2). The transformer 8 is divided into a primary side 9 and a secondary side 10. In particular, the primary side 9 comprises a primary coil 11, and the secondary side 10 is divided into a first secondary coil 12 and a second secondary coil 13.

The first DC converter 6 is in particular galvanically isolated and provides the first DC voltage U1. The first DC voltage U1 is then filtered by a DC voltage filter 14 and made available to the high-tension high-voltage battery 2.

A pre-charging circuit 15 can be connected upstream of the high-voltage battery 2, by means of which the high voltage battery 2 can be charged from the first DC voltage U1. In particular, the high-voltage battery 2 can be pre-charged via a second resistor R₂. Here, a pre-charging switch S_{V} is closed. It is also conceivable that an intermediate circuit capacitor C_{K} can be charged with the first DC voltage U1. Here, the pre-charging switch S_{V} and a first main contactor HS1 and a second main contactor HS2 are open. When the two main contactors HS1 and HS2 are closed, the high-voltage battery 2 can be charged via the intermediate circuit capacitor C_{K}. In particular, this makes it possible to dispense with a pre-charging circuit in the charger and in the high-voltage battery 2.

By way of example, the on-board charger 1 can be designed for a charging operation up to 3.7 kW at 230 V and 16 A.

FIG. 2 shows a schematic arrangement of the on-board charger 1 when charging the high-voltage battery 2. In particular, the high-voltage battery 2 is charged with the first DC voltage U1, which is generated with a first circuit of the secondary side 10 of the transformer 8 of the first DC converter 6. In particular, in the first circuit, the first secondary coil 12 of the secondary side 10 is active, and the second secondary coil 13 is deactivated. The activation of the secondary coil 12 and the second secondary coil 13 of the secondary side 10 is carried out in particular via a control unit 16 of the on-board charger 1. In particular, the control unit 16 ensures that either the first circuit or a second circuit of the secondary side 10 of the first DC converter 6 is active. Only the high-voltage battery 3 or the low-voltage battery 2 can be charged at any given time. When charging the high-voltage battery 2 with the first DC voltage U1, the switches S1, S2, S4 are open, and the switch S3 is closed. In particular, the control unit 16 clocks the charging operation to a required charging voltage for the high-voltage battery 2. The switches S1 to S4 may be mechanical switches or semiconductor switches. The use of mechanical switches and/or semiconductor switches depends on specific safety requirements for the vehicle.

In particular, charging of the high-voltage battery 2 takes place during the charging operation of the electrically operated vehicle. Since the low-voltage battery 3 or the second secondary coil 13 is deactivated during the charging operation of the high-voltage battery 2, a third DC voltage U3 is provided by means of a second DC converter 17 and thus supplies the low-voltage on-board electrical system or the low-voltage battery 3. By way of example, the second DC converter 17 can be integrated into the high-voltage battery 3. In particular, the second DC converter 17 serves to supply or ensure an emergency power supply for safety-relevant components of the vehicle. In particular, it should be possible to make an emergency call at any time in the event of an accident or a hazardous situation. This requires a minimum voltage. In particular, the second DC converter 17 can be used to ensure a supply of power to the emergency components when the high-voltage on-board electrical system or a high-voltage battery 2 is switched off or disconnected. In particular, a voltage of 12 V can be provided. The second DC converter 17 can be a mini-converter, for example.

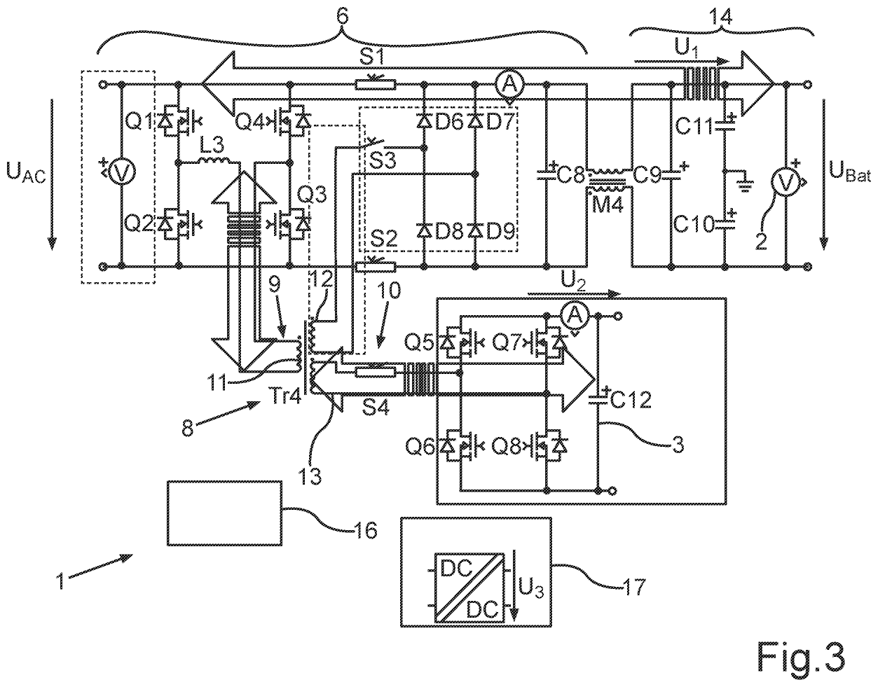

FIG. 3 shows a charging process of the low-voltage battery 3 using the on-board charger 1. In particular, the charging of the low-voltage battery 3 takes place in a driving mode of the electrically powered vehicle or the hybrid vehicle. During the charging operation of the low-voltage on-board electrical system, the switches S1, S2, S4 are closed, and the switch S3 is open. The low-voltage on-board electrical system or the low-voltage battery 3 is charged by means of the second circuit of the DC converter 6. In the second circuit, the first secondary coil 12 of the secondary side 10 is deactivated, and the second secondary coil 13 of the secondary side 10 is active. The activation or deactivation is performed by the control unit 16. With the help of the active second secondary coil 13, the conversion of the battery voltage U_{Bat} of the high-voltage battery 2 into the second DC voltage U2 is performed. In particular, the voltage level of the second DC voltage U2 is 12 V. In particular, during the charging process of the low-voltage battery 3, the control unit 16 is closed in such a way that, in particular, a 12 V on-board electrical system can be supplied. By way of example, the first DC converter 6 can be used to pre-charge the high-voltage on-board electrical system using the low-voltage battery 3. In particular, when the low-voltage battery 3 is actively charging, charging of the high-voltage battery 2 is not possible.

In particular, the on-board charger 1 comprises the functions of an on-board charger and a DC converter in that the on-board charger 1 uses the synergies of both functions. In particular, the functions of the on-board charger and the DC converter are merged in one housing or in one component as the on-board charger 1.

### LIST OF REFERENCE CHARACTERS

1 on-board charger
2 high-voltage battery
3 low-voltage battery
4 line filter
5 power factor correction filter
6 first DC converter
7 pre-charging circuit
8 transformer
9 primary side
10 secondary side
11 primary coil
12 first secondary coil
13 second secondary coil
14 DC voltage filter
15 pre-charging circuit
16 control unit
17 second DC converter
C_{K} intermediate circuit capacitor
HS1 first main contactor
HS2 second main contactor
U_{AC} AC voltage
U_{Bat} battery voltage
U1 bis U3 first to third DC voltage
S_{L}, S_{V} pre-charging switch
S1 bis S4 first switch to fourth switch
R₁, R₂ first and second resistor

1.-6. (canceled)

7. An on-board charger (1) for charging a high-voltage battery (2) of a high-voltage on-board electrical system or a low-voltage battery (3) of a low-voltage on-board electrical system, comprising:
a line filter (4) for filtering an AC voltage (U_{AC});
a power factor correction filter (5) for adjusting an input current;
a first DC converter (6) which has a transformer (8) having a primary side (9) and a secondary side (10), wherein the high-voltage battery (2) can be supplied with a first DC voltage (U1) using the first DC converter (6) via a first circuit of the secondary side (10) of the first DC converter (6),
a DC voltage filter (14);
a second circuit of the secondary side (10) of the first DC converter (6), wherein the low-voltage battery (3) can be supplied with a second DC voltage (U2) via the second circuit of the secondary side (10) of the first DC converter (6); and
a control unit (16) for activating either the first circuit or the second circuit of the secondary side (10) of the first DC converter (6);
wherein, for operating the low-voltage on-board electrical system by the high-voltage battery (2), the first DC converter (6) is configured such that the first DC converter (6) converts a battery voltage (U_{Bat}) of the high-voltage battery (2) into the second DC voltage (U2) in the second circuit of the secondary side (10).

8. The on-board charger according to claim 7, further comprising a second DC converter (17) wherein the low-voltage on-board electrical system can be supplied with a third DC voltage (U3) using the second DC converter (17).

9. The on-board charger (1) according to claim 8, wherein the second DC converter (17) is integrated in the high-voltage battery (2).

10. The on-board charger (1) according to claim 7, further comprising a pre-charging circuit (15) connected upstream of the high-voltage battery (2), wherein via the pre-charging circuit (15) the high-voltage battery (2) can be charged from the first DC voltage (U1).

11. A method for charging a high-voltage battery (2) of a high-voltage on-board electrical system or a low-voltage battery (3) of a low-voltage on-board electrical system, wherein the high-voltage battery (2) is charged with a first DC voltage (U1) which is generated with a first circuit of a secondary side (10) of a transformer (8) of a first DC converter (6) and wherein the low-voltage battery (3) is charged with a second DC voltage (U2) which is generated with a second circuit of the secondary side (10) of the first DC converter (6), comprising the steps of:
monitoring such that only the low-voltage battery (3) or only the high-voltage battery (2) is charged; and
when operating the low-voltage on-board electrical system by the high-voltage battery (2), the first DC converter (6) converts a battery voltage (U_{Bat}) of the high-voltage battery (2) into the second DC voltage (U2) in the second circuit of the secondary side (10).
